(19) United States
(12) Patent Application Publication
(10) Pub. No.: US 2012/0040238 A1
(43) Pub. Date: Feb. 16, 2012

(54) CONDUCTIVE CONNECTING STRUCTURE FOR A CORE ASSEMBLY OF A SECONDARY LITHIUM BATTERY

(76) Inventor: DONALD P.H. WU, Hsin-Feng Hsiang (TW)

(21) Appl. No.: 13/278,158

(22) Filed: Oct. 20, 2011

Related U.S. Application Data
(63) Continuation-in-part of application No. 11/534,302, filed on Sep. 22, 2006.

(51) Int. Cl. H01M 4/70; H01M 2/30

(52) U.S. Cl. 429/161

(57) ABSTRACT

A conductive connecting structure for a core assembly of a second lithium battery is used as an electrical conductive connection to connect the core assembly to the positive or negative lead terminal. The conductive connecting member is a flexible structure. By such arrangements, even if there is a dimension error in the core or the case, which can be overcome by the deformation of the conductive connecting structures, and thus the battery can be assembled successfully. The bolt enables the conductive connecting member to be maintained in a close electrical contact with the positive or negative lead area, and the connecting portion is electrically connected to the positive lead terminal or the negative lead terminal of the case.

This application is a continuation in part of U.S. patent application Ser. No. 11/534,302, claims 1-3 of this application are new, and claims 1-5 of the U.S. patent application Ser. No. 11/534,302 have been cancelled.

### BACKGROUND OF THE INVENTION

1. Field of the Invention

The present invention relates to an electrical connection structure for a core assembly of a second lithium battery, and more particularly to a design of the connection between the core assembly inside the battery and the positive or negative lead terminal on the case of the battery.

2. Description of the Prior Art

FIG. 1 shows of a conventional electrode assembly for a lithium secondary battery. The positive and negative layers of the electrode assembly 10 are formed at a side thereof with a large negative lead area 111 and a large uncoated positive lead area 112. In addition, a large collecting area 121 is formed in the mid of the lead terminal 12 and is located correspondingly to the negative lead area 111 or the positive lead area 112. And then a pressing piece 131 of the clasping assemblies 13 is fixed outside the positive lead area 111 or the negative lead area 112. In this way, the two conductive pressing pieces 131 are firmly pressed against the positive lead area 111 or the negative lead area 112. On the one hand, the respective layers of the positive lead area 111 or the negative lead area 112 are pressed closely against one another, and on the other hand, the positive lead area 111 or the negative lead area 112 is allowed to be maintained in a tight electrical contact with the collecting area 121 (as shown in FIG. 2).

It is to be noted that the size of the respective components of the abovementioned lithium secondary battery must be controlled precisely; otherwise, the electrode assembly cannot be fitted into the battery case, if the battery case, the core or the lead terminal has an error in dimension. For example, if the battery case is too short or the core is too high, the core cannot be sealed hermetically in the battery case, or, if the electrode assembly is too short, as a result, only one end of the electrode assembly can be fixed to the battery case, and the other end of the electrode assembly will be too short to reach the battery case, so it cannot be fixed.

The electrical connection process of the leads of the electrode assembly is simplified. However, the size of the components of the electrode assembly must be controlled precisely, otherwise the electrode assembly cannot be assembled.

The present invention has arisen to mitigate and/or obviate the afore-described disadvantages.

### SUMMARY OF THE INVENTION

The primary objective of the present invention is to provide a conductive connecting structure for a core assembly of a second lithium battery, wherein the conductive connecting structure is used as an electrical conductive connection for connecting the core assembly to the positive lead terminal or the negative lead terminal. The conductive connecting structure includes two bolts and two conductive connecting members, and each of the conductive connecting members is a flexible structure and consists of two conductive pressing pieces and a connecting portion. The conductive pressing pieces are disposed outside the positive lead area or the negative lead area, the bolt enables the conductive connecting member to be firmly pressed against and to be maintained in a close electrical contact with the positive lead area or the negative lead area, and the connecting portion is electrically connected to the positive lead terminal or the negative lead terminal of the case. By such arrangements, even if there is a dimension error in the core or the case, which can be overcome by the deformation of the conductive connecting structures, and thus the battery can be assembled successfully.

The secondary objective of the present invention is to provide a conductive connecting structure for a core assembly of a second lithium battery, wherein the conductive pressing pieces of the conductive connecting members are directly pressed against and maintained in a close electrical contact with the respective layers of the positive lead area or the negative lead area, and the conductive connecting members are electrically connected to the positive or negative lead terminal. Since the structure of the present invention is very simple and the electrical connection is direct, which contributes to reduction of the resistance of the battery.

To achieve the above objects, a conductive connecting structure for a core assembly of a secondary lithium battery in accordance with the present invention is disposed at both ends of the core and electrically connected to positive and negative terminals of a case of the secondary lithium battery, and comprises two conductive connecting members, each of which includes two conductive pressing pieces and a connecting portion. Each of the conductive pressing pieces is flexible and arc-shaped in cross section, namely concave inside and convex outside, and the concave inside of the each conductive pressing piece is a step structure formed by a thick portion and a thin portion. The two conductive pressing pieces are assembled with their concave insides facing each other, and then both ends of the connecting portion are connected to the thick portions of the conductive pressing pieces, so that the two conductive pressing pieces are connected to form an integral structure, and finally the connecting portions are electrically connected to the positive lead terminal and the negative lead terminal of the case, respectively, by such arrangements, the conductive connecting members can use the thick portions of the two conductive pressing pieces to hold the core of the core assembly while using the thin portions of the two conductive pressing pieces to hold the positive lead area or the negative lead area of the core in a clamping manner.

Two bolts are inserted through the conductive pressing pieces and the core to fix the conductive pressing pieces to the positive lead area or the negative lead area, thus establishing electric connection between the conductive pressing pieces and the positive lead area or the negative lead area.

### BRIEF DESCRIPTION OF THE DRAWINGS

FIG. 1 is a cross sectional view of a conventional core structure for a secondary lithium battery disclosed in U.S. application Ser. No. 11/456,119;

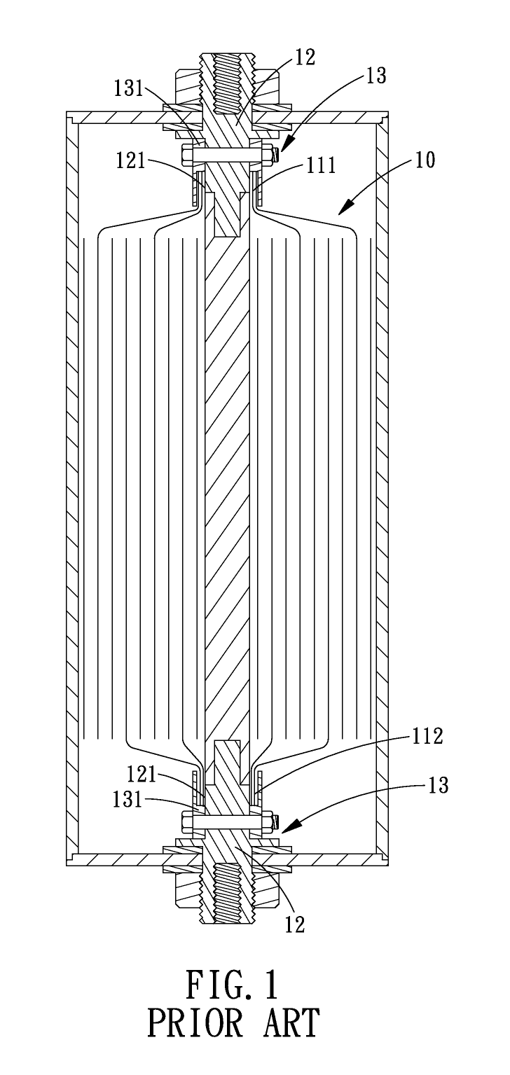

FIG. 2 is an exploded view of showing an electrical connection structure for a core assembly of a secondary lithium battery in accordance with the present invention;

FIG. 3 is an amplified view of showing a part of the core structure for a secondary lithium battery in accordance with the present invention;

FIG. 4 is a cross sectional view in accordance with the present invention of showing that the electrical connection structure for a core assembly is disposed in a circular battery case; and

FIG. 5 is a cross sectional view in accordance with the present invention of showing the interior of the battery case, wherein the core structure is additionally provided with conductive sleeve.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

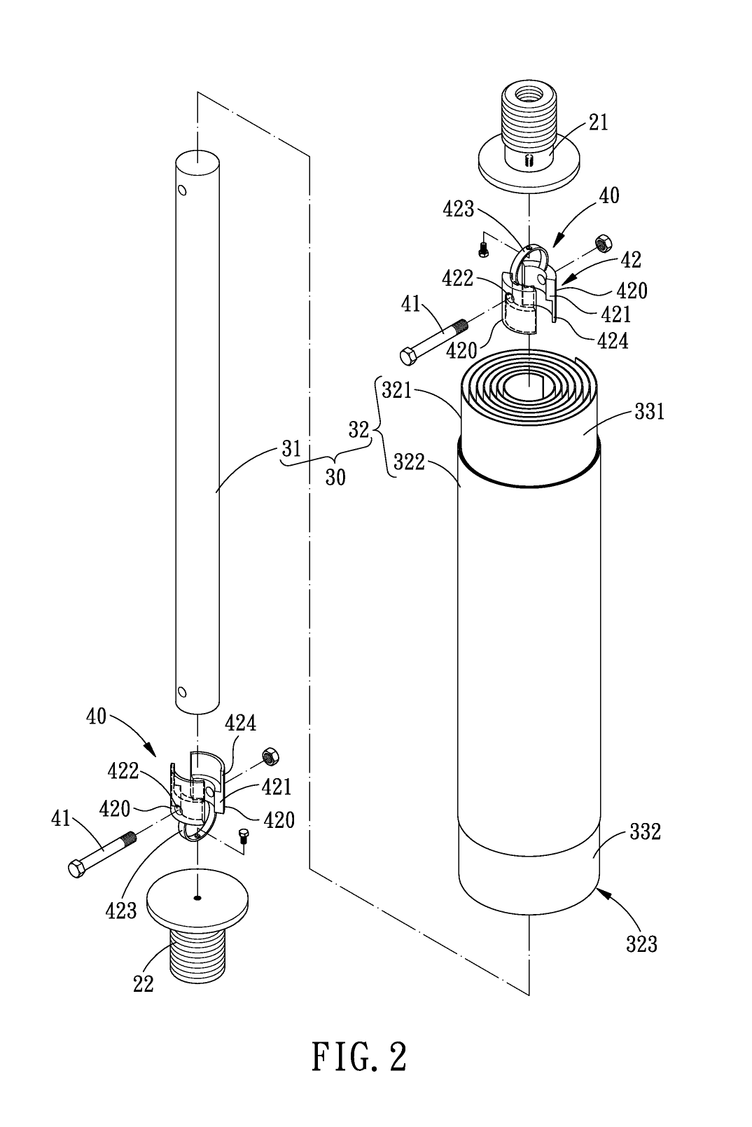

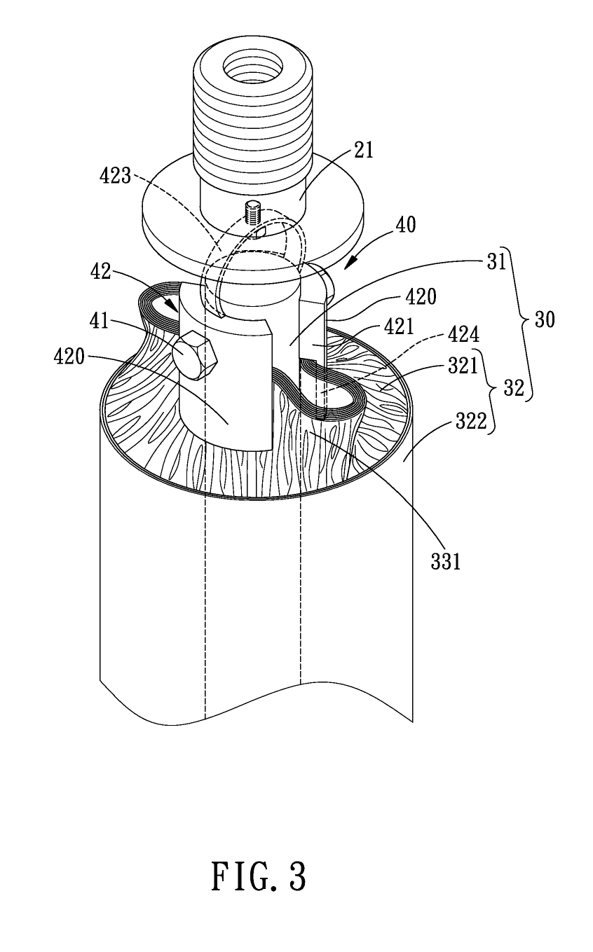

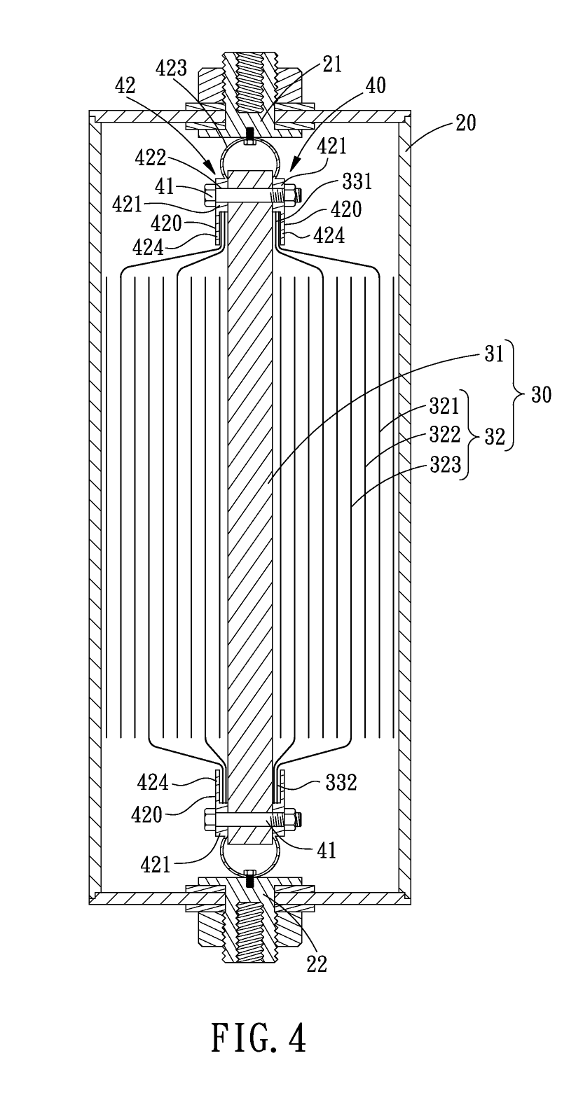

Referring to FIGS. 2-4, an electrical connection structure for a core assembly of a secondary lithium battery in accordance with the present invention is illustrated, wherein two conductive connecting structures 40 are arranged at both ends of the core assembly 30 and are electrically connected to the positive lead terminal 21 or the negative lead terminal 22 of the case 20 of the battery.

The core assembly 30 includes a core 31 and an electrode assembly 32. The electrode assembly 32 includes at least one positive layer 321, one separating layer 322 and one negative layer 323 that are superposed one another and then wind around the core 31. An uncoated area is formed at a side of the positive layer 321 for use as a positive lead area 331, and the negative layer 323 is formed at another side thereof opposite the positive layer 321 with an uncoated area for use as a negative lead area 332. The positive and negative lead areas 331, 332 protrude out of both sides of the core assembly 32.

Each of the conductive connecting structures 40 includes a bolt 41 and a conductive connecting member 42. The conductive connecting member 42 includes two conductive pressing pieces 420 and a connecting portion 423 formed between the conductive pressing pieces 420, and the connecting portion 423 is a curved arc-shaped structure. It is to be noted that each of the conductive pressing pieces 420 is flexible and arc-shaped (which is concave inside and convex outside) in cross section, and the concave inside of the each conductive pressing piece 420 is a step structure formed by a thick portion 421 and thin portion 424 which are connected together. The two conductive pressing pieces 420 are assembled with their concave insides facing each other, and then the both ends of the connecting portion 423 are connected to the thick portions 421 of the conductive pressing pieces 420, so that the two conductive pressing pieces 420 are connected to form an integral structure. The conductive pressing pieces 420 are disposed outside the positive lead area 331 or the negative lead area 332, and the bolt 41 is inserted through the through hole 422 of the conductive pressing pieces 420 and the core 31 to fix the conductive pressing pieces 420 to the positive lead area 331 or the negative lead area 332, thus establishing electric connection between the conductive pressing pieces 420 and the positive lead area 331 or the negative lead area 332, and finally the connecting portions 423 are electrically connected to the positive lead terminal 21 and the negative lead terminal 22 of the case 20, respectively. By such arrangements, the conductive connecting members 42 can use the thick portions 421 of the two conductive pressing pieces 421 to hold the core 31 of the core assembly 30 while using the thin portions 424 of the two conductive pressing pieces 421 to hold the positive lead area 331 or the negative lead area 332 of the core 31 in a clamping manner.

The core structure and the arrangement relation of the components thereof are mentioned above. The present invention intends to further improve the design of the core structure and to use the conductive connecting structures as an electrical conductive connection for connecting the conductive connecting structures 40 to the positive lead terminal 21 or the negative lead terminal 22 of the core 30, and each of the conductive connecting members 42 is a flexible structure. By such arrangements, even if there is a dimension error in the core 30 or the case 20, which can be overcome by the deformation of the conductive connecting members 42, and thus the battery can be assembled successfully.

Referring to FIGS. 2-4 again, the conductive connecting structures 40 serve as electrical conductive connection between the core assembly 30 and the positive lead terminal 21 or the negative lead terminal 22. Since each of the conductive pressing pieces 420 of the conductive connecting member 42 of the conductive connecting structures 40 is flexible, it can be deformed or lengthened to a certain extent. Therefore, even if there is a dimension error in the core or the case 20, which can be overcome by the deformation of the conductive connecting structures 40, and thus the core assembly 30 and the case 20 can be assembled successfully.

It is to be noted that the concave inside and convex outside arc-shaped thin portion 424 enables the conductive pressing pieces 420 of the conductive connecting members 42 to be directly pressed against the respective layers of the positive lead area 331 or the negative lead area 332, so as to establish electric connection between the conductive pressing pieces 420 and the positive lead area 331 or the negative lead area 332, and the conductive connecting members 42 are electrically connected to the positive lead terminal 21 and the negative lead terminal 22. Since the structure of the present invention is very simple and the electrical connection is direct, which contributes to the reduction of the resistance of the battery.

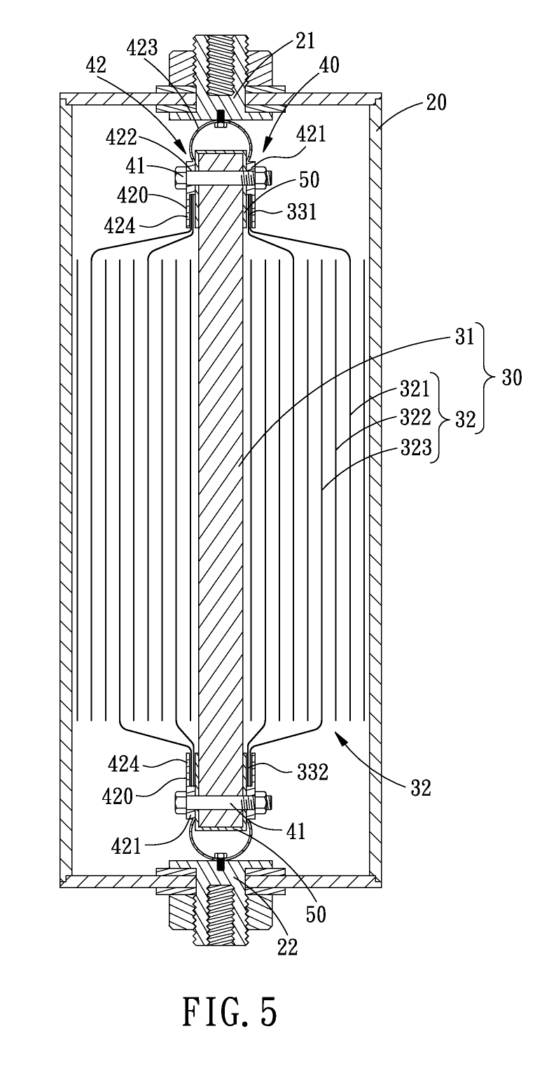

As shown in FIG. 5, either end of the core 31 can be covered with a conductive sleeve 50, when the conductive pressing pieces 420 are pressed against the positive and negative lead areas 331, 332, the conductive sleeve 50 can improve the electrical connection between the positive and negative lead areas 411, 431, thus increasing the current path in the charge and discharge process of the battery, and reducing the resistance of the battery.

While we have shown and described various embodiments in accordance with the present invention, it is clear to those skilled in the art that further embodiments may be made without departing from the scope of the present invention.

What is claimed is:

1. A conductive connecting structure for a core assembly of a secondary lithium battery being disposed at both ends of the core and electrically connected to positive and negative terminals of a case of the secondary lithium battery, comprising:
two conductive connecting members each including two conductive pressing pieces and a connecting portion, each of the conductive pressing pieces being flexible and arc-shaped in cross section, namely being concave inside and convex outside, and the concave inside of the each conductive pressing piece being a step structure formed by a thick portion and a thin portion, the two conductive pressing pieces being assembled with their concave insides facing each other, and then both ends of the connecting portion being connected to the thick portions of the conductive pressing pieces, so that the two conductive pressing pieces are connected to form an integral structure, and finally the connecting portions being electrically connected to the positive lead terminal and the negative lead terminal of the case, respectively, by such arrangements, the conductive connecting members use the thick portions of the two conductive pressing pieces to hold the core of the core assembly while using the thin portions of the two conductive pressing pieces to hold the positive lead area or the negative lead area of the core in a clamping manner;
two bolts being inserted through the conductive pressing pieces and the core to fix the conductive pressing pieces to the positive lead area or the negative lead area, thus establishing electric connection between the conductive pressing pieces and the positive lead area or the negative lead area.

2. The conductive connecting structure for a core assembly of a secondary lithium battery as claimed in claim 1, wherein either end of a core of the core assembly is covered with a conductive sleeve which is located between the conductive pressing pieces.

3. The conductive connecting structure for a core assembly of a secondary lithium battery as claimed in claim 1, wherein the connecting portion is a curved arc-shaped structure.
